(19) United States
(12) Patent Application Publication
(10) Pub. No.: US 2015/0143297 A1
(43) Pub. Date: May 21, 2015

(54) INPUT DETECTION FOR A HEAD MOUNTED DEVICE

(71) Applicants: Aaron Wheeler, San Francisco, CA (US); Sebastian Thrun, Los Altos Hills, CA (US)

(72) Inventors: Aaron Wheeler, San Francisco, CA (US); Sebastian Thrun, Los Altos Hills, CA (US)

(73) Assignee: GOOGLE INC., Mountain View, CA (US)

(21) Appl. No.: 13/302,345

(22) Filed: Nov. 22, 2011

(51) Int. Cl. G06F 3/0485; G09G 5/08; G02B 27/01; G06F 3/0482; G06F 3/01

(52) U.S. Cl. CPC G06F 3/0485; G06F 3/012; G02B 27/017; G06F 3/0482
USPC 715/830; 345/157

(57) ABSTRACT

Methods and devices for providing a user-interface are disclosed. In one aspect, a head-mounted-device system includes a processor data storage comprising user-interface logic executable by the at least one processor to receive data corresponding to first position of a head-mounted display (HMD) and responsively cause the HMD to display a user-interface comprising a view region, at least one content region located above the view region, and a history region located below the view region. The user-interface logic is further executable to receive data corresponding to an left or right movement of the HMD and responsively cause the HMD to move the field of view such that the at least one content region becomes more visible, for example, scrolling an item in a user interface. The scrolling may have a non-linear relationship with the head movement speed.

### BACKGROUND

Unless otherwise indicated herein, the materials described in this section are not prior art to the claims in this application and are not admitted to be prior art by inclusion in this section.

Various technologies can be utilized to display information to a user of a system. Some systems for displaying information may utilize “heads-up” displays. A heads-up display is typically positioned near the user's eyes to allow the user to view displayed images or information within the user's field of view. To generate the images on the display, a computer processing system may be used. Such heads-up displays have a variety of applications, such as aviation information systems, vehicle navigation systems, and video games.

One type of heads-up display is a head-mounted display. A head-mounted display can be incorporated into a pair of glasses that the user can wear. The display may include a user interface. The user interface may have various components. Some components may be graphics and other components may be words. One component of the user interface may be a list of items. Additionally, there may be various ways the user could interact with the user interface of the heads up display.

### SUMMARY

Disclosed herein are improved methods and devices for controlling and interfacing with a wearable heads-up display. In an exemplary embodiment, the wearable heads-up display may include a processor, a display element configured to receive display information from the processor and to display the display information. A user of the heads-up display may interact with items in the display with movements of his or her head. In this manner, a user may be able to interact with the heads-up display without any touching of the hardware. For example, a user may interact with a heads-up display with a head movement.

In a further example, the user interface may display a list of items, such as a list of program, a list of emails, and a list of input characters. In order to select one of the items displayed on the heads up display, a user may turn his or her head in a direction, left, right, up, or down. When a user moves his or head in a direction, the user interface shown on the display may update responsively. In one embodiment, the head movement may be mapped to a scrolling or other movement action of an element within the user interface. The element may scroll in response to the head movement. For example, a head turn to the left may cause the items in the list on the user interface to scroll to the right. The speed of the scrolling may be a mathematical function based on the speed of the head movement. In one embodiment, the speed of the head movement is mapped via a non-linear mathematical function to the speed of the scrolling. In some additional embodiments, other parameters of the head movement may be used to calculate the scrolling speed. For example, the parameter may be the acceleration of the heads-up display, the position of the heads up display, or any other parameter.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A illustrates an example system for receiving, transmitting, and displaying data.

FIG. 1B illustrates an alternate view of the system illustrated in FIG. 1A.

FIG. 2A illustrates an example system for receiving, transmitting, and displaying data.

FIG. 2B illustrates an example system for receiving, transmitting, and displaying data.

FIG. 3 shows a simplified block diagram of an example computer network infrastructure.

FIG. 4 shows a simplified block diagram depicting example components of an example computing system.

FIG. 5A shows aspects of an example user-interface.

FIG. 5B shows aspects of an example user-interface after receiving movement data corresponding to an upward movement.

FIG. 5C shows aspects of an example user-interface after selection of a selected content object.

FIG. 5D shows aspects of an example user-interface after receiving input data corresponding to a user input.

FIG. 6A shows an example head movement for interacting with the user interface.

FIG. 6B shows an example scrolling user interface element.

FIG. 6C shows an example scrolling user interface element.

FIG. 7A shows an example text entry system.

FIG. 7B shows an example scrolling selection in a text entry system.

FIG. 8 shows an example method for interacting with the user interface.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### 1. OVERVIEW

The methods and systems disclosed herein generally relate to controlling a user interface present in a wearable computing device. In some example embodiments, the wearable computing device include a heads-up display, which could be configured as a pair of glasses. The user interface may appear within the field of view of a person wearing the heads up display. To operate the user interface, the person may move his or her head. For example, in order to move through a list of items, a person may turn his or her head to the left or right. The user interface may scroll through a list of items based on the head movement of the person wearing the wearable computing device.

### 2. EXAMPLE SYSTEM AND DEVICE ARCHITECTURE

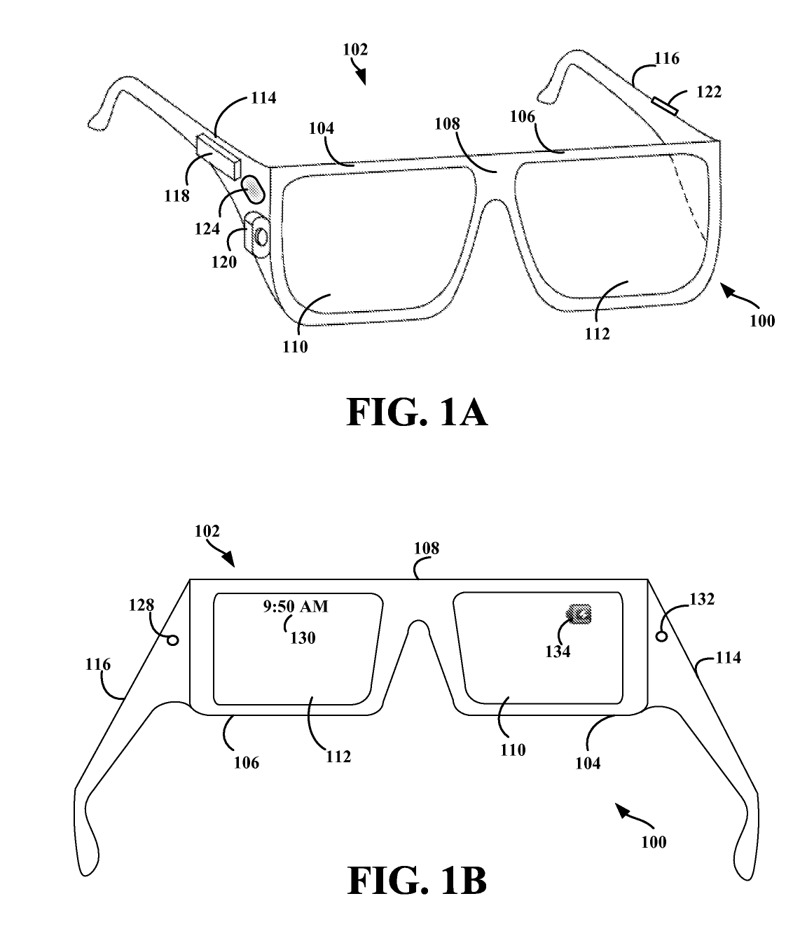

FIG. 1A illustrates an example system 100 for receiving, transmitting, and displaying data. The system 100 is shown in the form of a wearable computing device. While FIG. 1A illustrates a head-mounted device 102 as an example of a wearable computing device, other types of wearable computing devices could additionally or alternatively be used. As illustrated in FIG. 1A, the head-mounted device 102 has frame elements including lens-frames 104, 106 and a center frame support 108, lens elements 110, 112, and extending side-arms 114, 116. The center frame support 108 and the extending side-arms 114, 116 are configured to secure the head-mounted device 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the head-mounted device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements 110, 112.

The extending side-arms 114, 116 may each be projections that extend away from the lens-frames 104, 106, respectively, and may be positioned behind a user's ears to secure the head-mounted device 102 to the user. The extending side-arms 114, 116 may further secure the head-mounted device 102 to the user by extending around a rear portion of the user's head. Additionally or alternatively, for example, the system 100 may connect to or be affixed within a head-mounted helmet structure. Other possibilities exist as well.

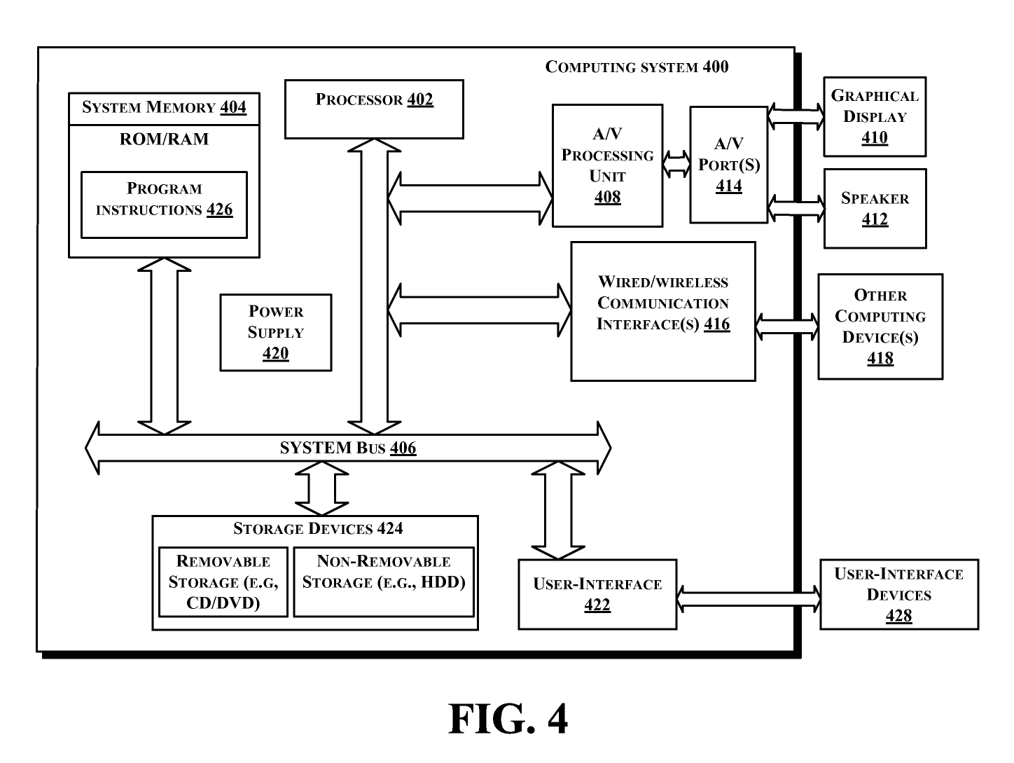

The system 100 may also include an on-board computing system 118, a video camera 120, a sensor 122, and a finger-operable touch pad 124. The on-board computing system 118 is shown to be positioned on the extending side-arm 114 of the head-mounted device 102; however, the on-board computing system 118 may be provided on other parts of the head-mounted device 102 or may be positioned remote from the head-mounted device 102 (e.g., the on-board computing system 118 could be connected by wires or wirelessly connected to the head-mounted device 102). The on-board computing system 118 may include a processor and memory, for example. The on-board computing system 118 may be configured to receive and analyze data from the video camera 120, the sensor 122, and the finger-operable touch pad 124 (and possibly from other sensory devices, user-interfaces, or both) and generate images for output by the lens elements 110 and 112. The on-board computing system 118 may additionally include a speaker or a microphone for user input (not shown). An example computing system is further described below in connection with FIG. 4.

The video camera 120 is shown positioned on the extending side-arm 114 of the head-mounted device 102; however, the video camera 120 may be provided on other parts of the head-mounted device 102. The video camera 120 may be configured to capture images at various resolutions or at different frame rates. Video cameras with a small form-factor, such as those used in cell phones or webcams, for example, may be incorporated into an example embodiment of the system 100.

Further, although FIG. 1A illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown on the extending side-arm 116 of the head-mounted device 102; however, the sensor 122 may be positioned on other parts of the head-mounted device 102. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the head-mounted device 102. However, the finger-operable touch pad 124 may be positioned on other parts of the head-mounted device 102. Also, more than one finger-operable touch pad may be present on the head-mounted device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

FIG. 1B illustrates an alternate view of the system 100 illustrated in FIG. 1A. As shown in FIG. 1B, the lens elements 110, 112 may act as display elements. The head-mounted device 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may be omitted (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or light emitting diode (LED) source and scanning system could be used to draw a raster display directly onto the retina of one or more of the user's eyes. Other possibilities exist as well.

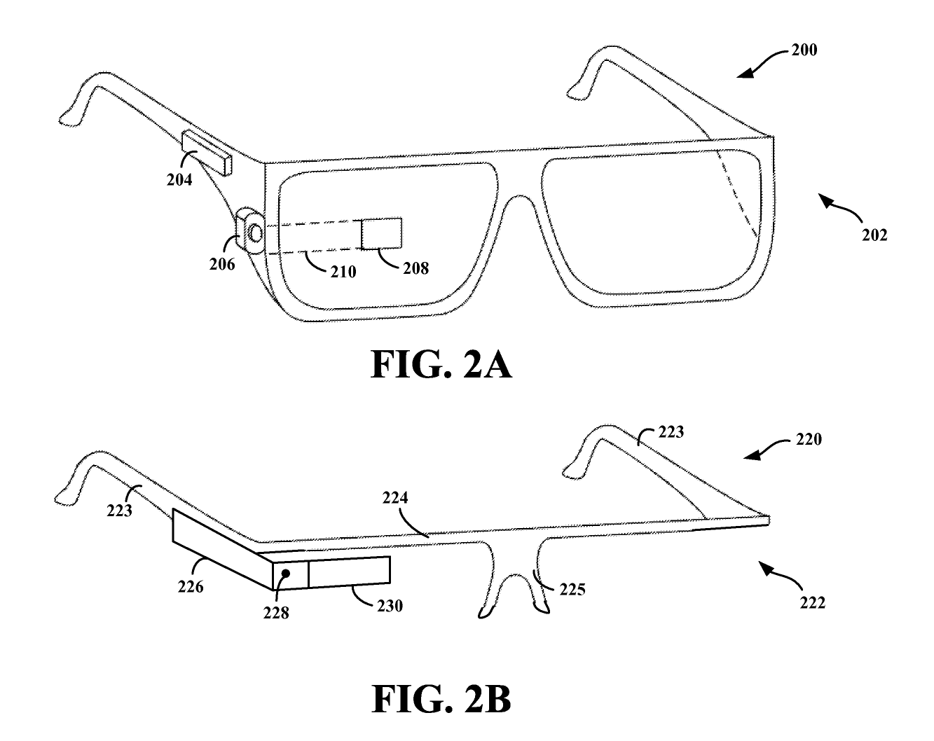

FIG. 2A illustrates an example system 200 for receiving, transmitting, and displaying data. The system 200 is shown in the form of a wearable computing device 202. The wearable computing device 202 may include frame elements and side-arms such as those described with respect to FIGS. 1A and 1B. The wearable computing device 202 may additionally include an on-board computing system 204 and a video camera 206, such as those described with respect to FIGS. 1A and 1B. The video camera 206 is shown mounted on a frame of the wearable computing device 202; however, the video camera 206 may be mounted at other positions as well.

As shown in FIG. 2A, the wearable computing device 202 may include a single display 208 which may be coupled to the device. The display 208 may be formed on one of the lens elements of the wearable computing device 202, such as a lens element described with respect to FIGS. 1A and 1B, and may be configured to overlay computer-generated graphics in the user's view of the physical world. The display 208 is shown to be provided in a center of a lens of the wearable computing device 202, however, the display 208 may be provided in other positions. The display 208 is controllable via the computing system 204 that is coupled to the display 208 via an optical waveguide 210.

FIG. 2B illustrates an example system 220 for receiving, transmitting, and displaying data. The system 220 is shown in the form of a wearable computing device 222. The wearable computing device 222 may include side-arms 223, a center frame support 224, and a bridge portion with nosepiece 225. In the example shown in FIG. 2B, the center frame support 224 connects the side-arms 223. The wearable computing device 222 does not include lens-frames containing lens elements. The wearable computing device 222 may additionally include an on-board computing system 226 and a video camera 228, such as those described with respect to FIGS. 1A and 1B.

The wearable computing device 222 may include a single lens element 230 that may be coupled to one of the side-arms 223 or the center frame support 224. The lens element 230 may include a display such as the display described with reference to FIGS. 1A and 1B, and may be configured to overlay computer-generated graphics upon the user's view of the physical world. In one example, the single lens element 230 may be coupled to a side of the extending side-arm 223. The single lens element 230 may be positioned in front of or proximate to a user's eye when the wearable computing device 222 is worn by a user. For example, the single lens element 230 may be positioned below the center frame support 224, as shown in FIG. 2B.

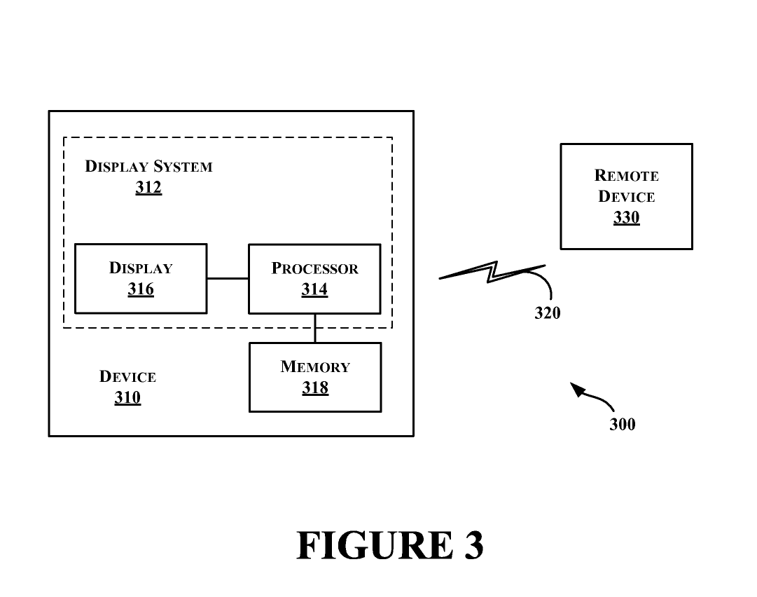

FIG. 3 shows a simplified block diagram of an example computer network infrastructure. In system 300, a device 310 communicates using a communication link 320 (e.g., a wired or wireless connection) to a remote device 330. The device 310 may be any type of device that can receive data and display information corresponding to or associated with the data. For example, the device 310 may be a heads-up display system, such as the head-mounted device 102, 200, or 220 described with reference to FIGS. 1A-2B.

Thus, the device 310 may include a display system 312 comprising a processor 314 and a display 316. The display 316 may be, for example, an optical see-through display, an optical see-around display, or a video see-through display. The processor 314 may receive data from the remote device 330, and configure the data for display on the display 316. The processor 314 may be any type of processor, such as a micro-processor or a digital signal processor, for example.

The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, or tablet computing device, etc., that is configured to transmit data to the device 310. The remote device 330 and the device 310 may contain hardware to enable the communication link 320, such as processors, transmitters, receivers, antennas, etc.

In FIG. 3, the communication link 320 is illustrated as a wireless connection; however, wired connections may also be used. For example, the communication link 320 may be a wired serial bus such as a universal serial bus or a parallel bus, among other connections. The communication link 320 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Either of such a wired and/or wireless connection may be a proprietary connection as well. The remote device 330 may be accessible via the Internet and may include a computing cluster associated with a particular web service (e.g., social-networking, photo sharing, address book, etc.).

As described above in connection with FIGS. 1A-2B, an example wearable computing device may include, or may otherwise be communicatively coupled to, a computing system, such as computing system 118 or computing system 204. FIG. 4 shows a simplified block diagram depicting example components of an example computing system 400. One or both of the device 310 and the remote device 330 may take the form of computing system 400.

Computing system 400 may include at least one processor 402 and system memory 404. In an example embodiment, computing system 400 may include a system bus 406 that communicatively connects processor 402 and system memory 404, as well as other components of computing system 400. Depending on the desired configuration, processor 402 can be any type of processor including, but not limited to, a microprocessor (μP), a microcontroller (μC), a digital signal processor (DSP), or any combination thereof. Furthermore, system memory 404 can be of any type of memory now known or later developed including but not limited to volatile memory (such as RAM), non-volatile memory (such as ROM, flash memory, etc.) or any combination thereof.

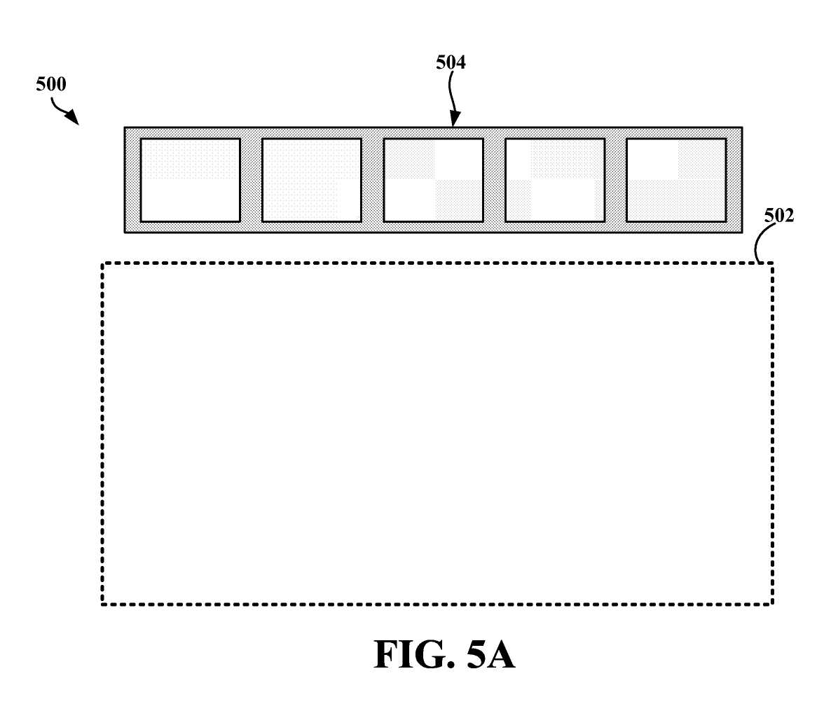

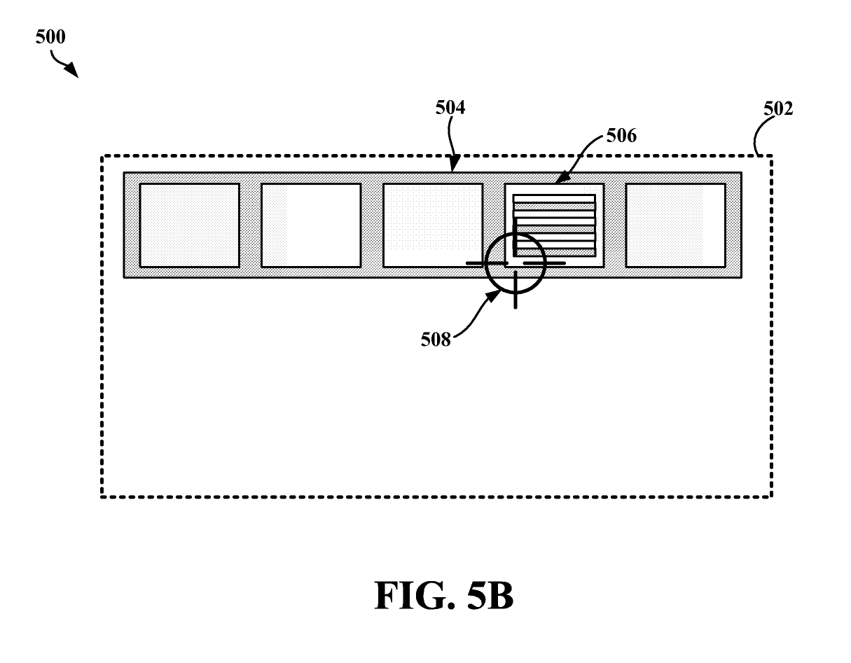

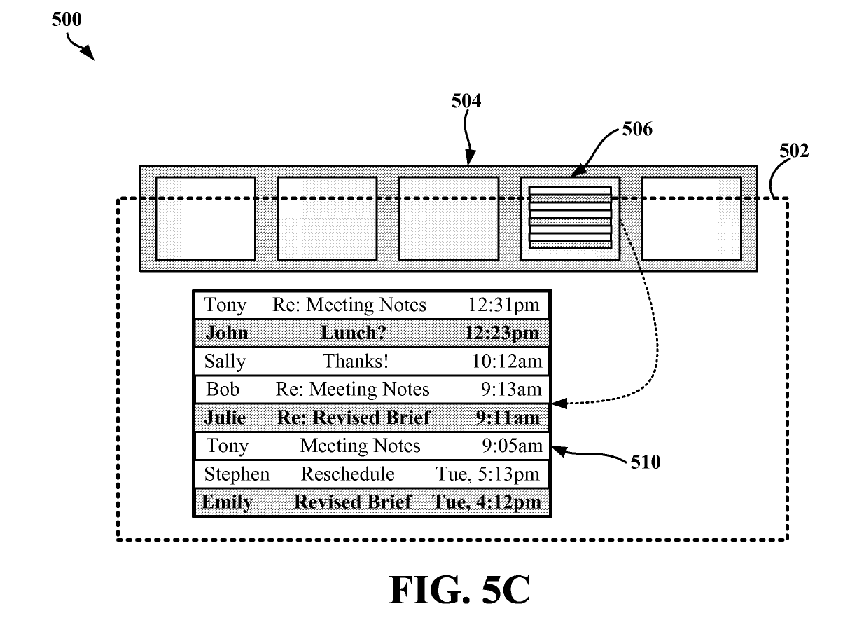

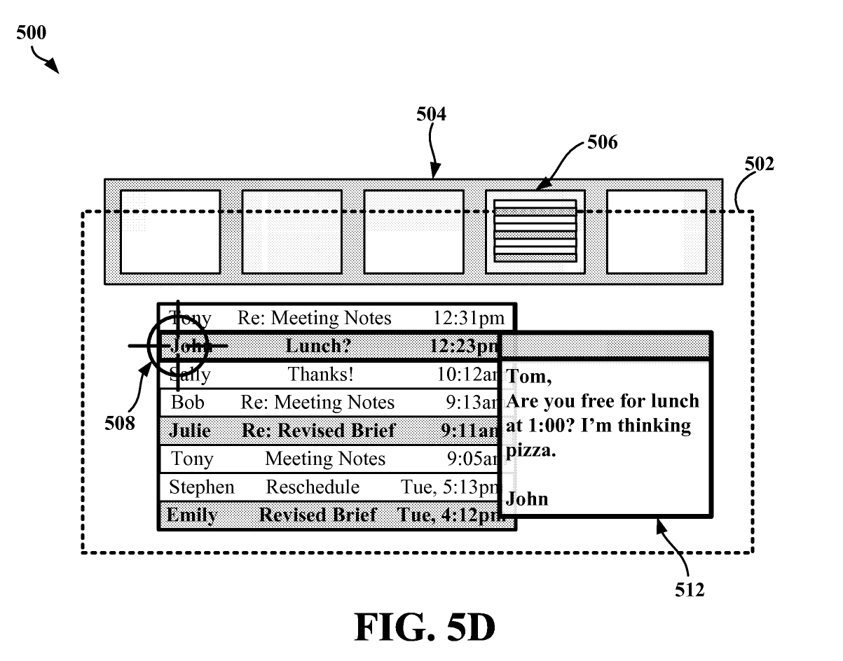

An example computing system 400 may include various other components as well. For example, computing system 400 includes an A/V processing unit 408 for controlling graphical display 410 and speaker 412 (via A/V port 414), one or more communication interfaces 416 for connecting to other computing devices 418, and a power supply 420. Graphical display 410 may be arranged to provide a visual depiction of various input regions provided by user-interface module 422. For example, user-interface module 422 may be configured to provide a user-interface, such as the example user-interface described below in connection with FIGS. 5A-D, and graphical display 410 may be configured to provide a visual depiction of the user-interface. User-interface module 422 may be further configured to receive data from and transmit data to (or be otherwise compatible with) one or more user-interface devices 428.

Furthermore, computing system 400 may also include one or more data storage devices 424, which can be removable storage devices, non-removable storage devices, or a combination thereof. Examples of removable storage devices and non-removable storage devices include magnetic disk devices such as flexible disk drives and hard-disk drives (HDD), optical disk drives such as compact disk (CD) drives or digital versatile disk (DVD) drives, solid state drives (SSD), and/or any other storage device now known or later developed. Computer storage media can include volatile and nonvolatile, removable and non-removable media implemented in any method or technology for storage of information, such as computer readable instructions, data structures, program modules, or other data. For example, computer storage media may take the form of RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium now known or later developed that can be used to store the desired information and which can be accessed by computing system 400.

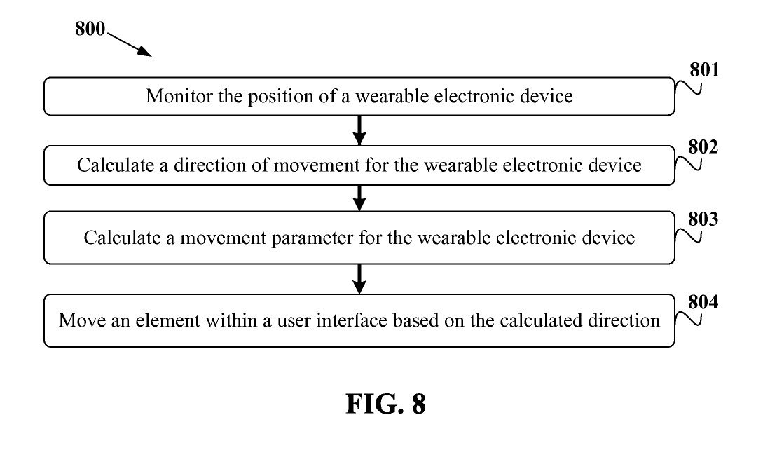

According to an example embodiment, computing system 400 may include program instructions 426 that are stored in system memory 404 (and/or possibly in another data-storage medium) and executable by processor 402 to facilitate the various functions described herein including, but not limited to, those functions described with respect to FIG. 8. Although various components of computing system 400 are shown as distributed components, it should be understood that any of such components may be physically integrated and/or distributed according to the desired configuration of the computing system.

### 3. EXAMPLE USER-INTERFACE

FIGS. 5A-D show aspects of an example user-interface 500. The user-interface 500 may be displayed by, for example, a wearable computing device as described above for FIGS. 1A-2B.

An example state of the user-interface 500 is shown in FIG. 5A. The example state shown in FIG. 5A may correspond to a first position of the wearable computing device. That is, the user-interface 500 may be displayed as shown in FIG. 5A when the wearable computing device is in the first position. In some embodiments, the first position of the wearable computing device may correspond to a position of the wearable computing device when a wearer of the wearable computing device is looking in a direction that is generally parallel to the ground (e.g., a position that does not correspond to the wearer looking up or looking down). Other examples are possible as well.

As shown, the user-interface 500 includes a view region 502. An example boundary of the view region 502 is shown by a dotted frame. While the view region 502 is shown to have a landscape shape (in which the view region 502 is wider than it is tall), in other embodiments the view region 502 may have a portrait or square shape, or may have a non-rectangular shape, such as a circular or elliptical shape. The view region 502 may have other shapes as well.

The view region 502 may be, for example, the viewable area between (or encompassing) the upper, lower, left, and right boundaries of a display on the wearable computing device. As shown, when the wearable computing device is in the first position, the view region 502 is substantially empty (e.g., completely empty) of user-interface elements, such that the user's view of their real-world environment is generally uncluttered, and objects in the user's environment are not obscured.

In some embodiments, the view region 502 may correspond to a field of view of a wearer of the wearable computing device, and an area outside the view region 502 may correspond to an area outside the field of view of the wearer. In other embodiments, the view region 502 may correspond to a non-peripheral portion of a field of view of a wearer of the wearable computing device, and an area outside the view region 502 may correspond to a peripheral portion of the field of view of the wearer. In still other embodiments, the user-interface 500 may be larger than or substantially the same as a field of view of a wearer of the wearable computing device, and the field of view of the wearer may be larger than or substantially the same size as the view region 502. The view region 502 may take other forms as well.

Accordingly, the portions of the user-interface 500 outside of the view region 502 may be outside of or in a peripheral portion of a field of view of a wearer of the wearable computing device. For example, as shown, a menu 504 may be outside of or in a peripheral portion of the field of view of the user in the user-interface 500. While the menu 504 is shown to be not visible in the view region 502, in some embodiments the menu 504 may be partially visible in the view region 502.

In some embodiments, the wearable computing device may be configured to receive movement data corresponding to, for example, an upward movement of the wearable computing device to a position above the first position. In these embodiments, the wearable computing device may, in response to receiving the movement data corresponding to the upward movement, cause one or both of the view region 502 and the menu 504 to move such that the menu 504 becomes more visible in the view region 502. For example, the wearable computing device may cause the view region 502 to move upward and may cause the menu 504 to move downward. The view region 502 and the menu 504 may move the same amount, or may move different amounts. In one embodiment, the menu 504 may move further than the view region 502. As another example, the wearable computing device may cause only the menu 504 to move. Other examples are possible as well, and are discussed in section 4 below.

While the term “upward” is used, it is to be understood that the upward movement may encompass any movement having any combination of moving, tilting, rotating, shifting, sliding, or other movement that results in a generally upward movement. Further, in some embodiments “upward” may refer to an upward movement in the reference frame of a wearer of the wearable computing device. Other reference frames are possible as well. In embodiments where the wearable computing device is a head-mounted device, the upward movement of the wearable computing device may also be an upward movement of a wearer's head such as, for example, the user looking upward.

The movement data corresponding to the upward movement may take several forms. For example, the movement data may be (or may be derived from) data received from one or more movement sensors, accelerometers, and/or gyroscopes configured to detect the upward movement, such as the sensor 122 described above in connection with FIG. 1A. In some embodiments, the movement data may comprise a binary indication corresponding to the upward movement. In other embodiments, the movement data may comprise an indication corresponding to the upward movement as well as an extent of the upward movement. The movement data may take other forms as well.

FIG. 5B shows aspects of an example user-interface after receiving movement data corresponding to an upward movement. As shown, the user-interface 500 includes the view region 502 and the menu 504.

As noted above, in response to receiving the movement data corresponding to an upward movement of the wearable computing device, the wearable computing device may move one or both of the view region 502 and the menu 504 such that the menu 504 becomes more visible in the view region 502.

As shown, the menu 504 is fully visible in the view region 502. In other embodiments, however, only a portion of the menu 504 may be visible in the view region 502. In some embodiments, the extent to which the menu 504 is visible in the view region 502 may be based at least in part on an extent of the upward movement.

Thus, the view region 502 may be moved in response to receiving data corresponding to an upward movement. In some embodiments, the view region 502 may be moved in an upward scrolling or panning motion. For instance, the view region 502 may appear to a wearer of the wearable computing device as if mapped onto the inside of a static sphere centered at the wearable computing device, and movement of the view region 502 may map onto movement of the real-world environment relative to the wearable computing device. A speed, acceleration, and/or magnitude of the upward scrolling may be based at least in part on a speed, acceleration, and/or magnitude of the upward movement. In other embodiments, the view region 502 may be moved by, for example, jumping between fields of view. In still other embodiments, the view region 502 may be moved only when the upward movement exceeds a threshold speed, acceleration, and/or magnitude. In response to receiving data corresponding to an upward movement that exceeds such a threshold or thresholds, the view region 502 may pan, scroll, slide, or jump to a new field of view. The view region 502 may be moved in other manners as well.

While the foregoing description focused on upward movement, it is to be understood that the wearable computing device could be configured to receive data corresponding to other directional movement (e.g., downward, leftward, rightward, etc.) as well, and that the view region 502 may be moved in response to receiving such data in a manner similar to that described above in connection with upward movement.

As shown, the menu 504 includes a number of content objects 506. In some embodiments, the content objects 506 may be arranged in a ring (or partial ring) around and above the head of a wearer of the wearable computing device. In other embodiments, the content objects 506 may be arranged in a dome-shape above the wearer's head. The ring or dome may be centered above the wearable computing device and/or the wearer's head. In other embodiments, the content objects 506 may be arranged in other ways as well.

The number of content objects 506 in the menu 504 may be fixed or may be variable. In embodiments where the number is variable, the content objects 506 may vary in size according to the number of content objects 506 in the menu 504. In embodiments where the content objects 506 extend circularly around a wearer's head, like a ring (or partial ring), only some of the content objects 506 may be visible at a particular moment. In order to view other content objects 504, a wearer of the wearable computing device may interact with the wearable computing device to, for example, rotate the content objects 506 along a path (e.g., clockwise or counterclockwise) around the wearer's head. To this end, the wearable computing device may be configured to receive data indicating such an interaction through, for example, a touch pad, such as finger-operable touch pad 124. Alternatively or additionally, the wearable computing device may be configured to receive such data through other input devices as well.

Depending on the application of the wearable computing device, the content objects 506 may take several forms. For example, the content objects 506 may include one or more of people, contacts, groups of people and/or contacts, calendar items, lists, notifications, alarms, reminders, status updates, incoming messages, recorded media, audio recordings, video recordings, photographs, digital collages, previously-saved states, webpages, and applications, as well as tools, such as a still camera, a video camera, and an audio recorder. Content objects 506 may take other forms as well.

In embodiments where the content objects 506 include tools, the tools may be located in a particular region of the menu 504, such as the center. In some embodiments, the tools may remain in the center of the menu 504, even if the other content objects 506 rotate, as described above. Tool content objects may be located in other regions of the menu 504 as well.

The particular content objects 506 that are included in menu 504 may be fixed or variable. For example, the content objects 506 may be preselected by a wearer of the wearable computing device. In another embodiment, the content objects 506 for each content region may be automatically assembled by the wearable computing device from one or more physical or digital contexts including, for example, people, places, and/or objects surrounding the wearable computing device, address books, calendars, social-networking web services or applications, photo sharing web services or applications, search histories, and/or other contexts. Further, some content objects 506 may be fixed, while the content objects 506 may be variable. The content objects 506 may be selected in other manners as well.

Similarly, an order or configuration in which the content objects 506 are displayed may be fixed or variable. In one embodiment, the content objects 506 may be pre-ordered by a wearer of the wearable computing device. In another embodiment, the content objects 506 may be automatically ordered based on, for example, how often each content object 506 is used (on the wearable computing device only or in other contexts as well), how recently each content object 506 was used (on the wearable computing device only or in other contexts as well), an explicit or implicit importance or priority ranking of the content objects 506, and/or other criteria.

In some embodiments, the wearable computing device may be further configured to receive from the wearer a selection of a content object 506 from the menu 504. To this end, the user-interface 500 may include a cursor 508, shown in FIG. 5B as a reticle, which may be used to navigate to and select content objects 506 from the menu 504. In some embodiments, the cursor 508 may be controlled by a wearer of the wearable computing device through one or more predetermined movements. Accordingly, the wearable computing device may be further configured to receive selection data corresponding to the one or more predetermined movements.

The selection data may take several forms. For example, the selection data may be (or may be derived from) data received from one or more movement sensors, accelerometers, gyroscopes, and/or detectors configured to detect the one or more predetermined movements. The one or more movement sensors may be included in the wearable computing device, like the sensor 122, or may be included in a peripheral device communicatively coupled to the wearable computing device. As another example, the selection data may be (or may be derived from) data received from a touch pad, such as the finger-operable touch pad 124 described above in connection with FIG. 1A, or other input device included in or coupled to the wearable computing device and configured to detect one or more predetermined movements. In some embodiments, the selection data may take the form of a binary indication corresponding to the predetermined movement. In other embodiments, the selection data may indicate the extent, the direction, the velocity, and/or the acceleration associated with the predetermined movement. The selection data may take other forms as well.

The predetermined movements may take several forms. In some embodiments, the predetermined movements may be certain movements or sequence of movements of the wearable computing device or peripheral device. In some embodiments, the predetermined movements may include one or more predetermined movements defined as no or substantially no movement, such as no or substantially no movement for a predetermined period of time. In embodiments where the wearable computing device is a head-mounted device, one or more predetermined movements may involve a predetermined movement of the wearer's head (which is assumed to move the wearable computing device in a corresponding manner). Alternatively or additionally, the predetermined movements may involve a predetermined movement of a peripheral device communicatively coupled to the wearable computing device. The peripheral device may similarly be wearable by a wearer of the wearable computing device, such that the movement of the peripheral device may follow a movement of the wearer, such as, for example, a movement of the wearer's hand. Still alternatively or additionally, one or more predetermined movements may be, for example, a movement across a finger-operable touch pad or other input device. Other predetermined movements are possible as well.

As shown, a wearer of the wearable computing device has navigated the cursor 508 to the content object 506 using one or more predetermined movements. In order to select the content object 506, the wearer may perform an additional predetermined movement, such as holding the cursor 508 over the content object 506 for a predetermined period of time. The wearer may select the content object 506 in other manners as well.

Once a content object 506 is selected, the wearable computing device may cause the content object 506 to be displayed in the view region 502 as a selected content object. FIG. 5C shows aspects of an example user-interface after selection of a selected content object, in accordance with an embodiment.

As indicated by the dotted arrow, the content object 506 is displayed in the view region 502 as a selected content object 510. As shown, the selected content object 510 is displayed larger and in more detail in the view region 502 than in the menu 504. In other embodiments, however, the selected content object 510 could be displayed in the view region 502 smaller than or the same size as, and in less detail than or the same detail as, the menu 504. In some embodiments, additional content (e.g., actions to be applied to, with, or based on the selected content object 510, information related to the selected content object 510, and/or modifiable options, preferences, or parameters for the selected content object 510, etc.) may be showed adjacent to or nearby the selected content object 510 in the view region 502.

### 4. EXAMPLE USER INTERACTION

Once the selected content object 510 is displayed in the view region 502, a wearer of the wearable computing device may interact with the selected content object 510. For example, as the selected content object 510 is shown as an email inbox, the wearer may wish to read one of the emails in the email inbox. Depending on the selected content object, the wearer may interact with the selected content object in other ways as well (e.g., the wearer may locate additional information related to the selected content object 510, modify, augment, and/or delete the selected content object 510, etc.). To this end, the wearable computing device may be further configured to receive input data corresponding to one or more predetermined movements indicating interactions with the user-interface 500. The input data may take any of the forms described above in connection with the selection data.

FIG. 5D shows aspects of an example user-interface after receiving input data corresponding to a user input, in accordance with an embodiment. As shown, a wearer of the wearable computing device has navigated the cursor 508 to a particular subject line in the email inbox and selected the subject line. As a result, the email 512 is displayed in the view region, so that the wearer may read the email 512. The wearer may interact with the user-interface 500 in other manners as well, depending on, for example, the selected content object.

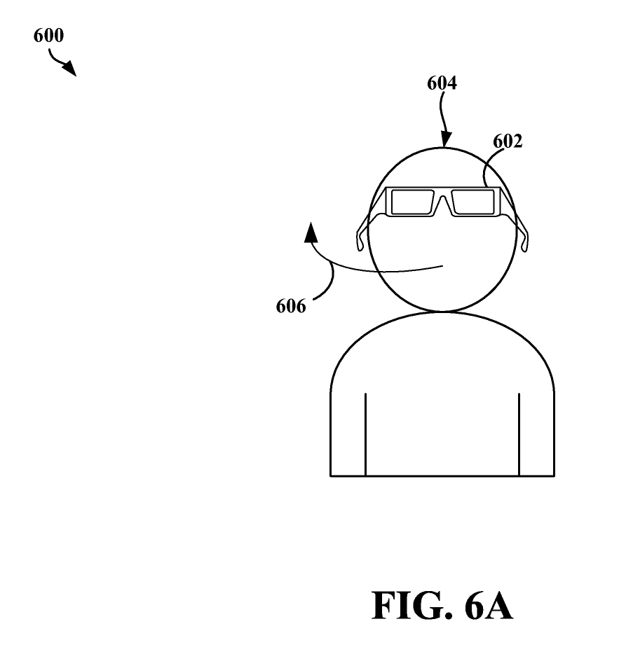

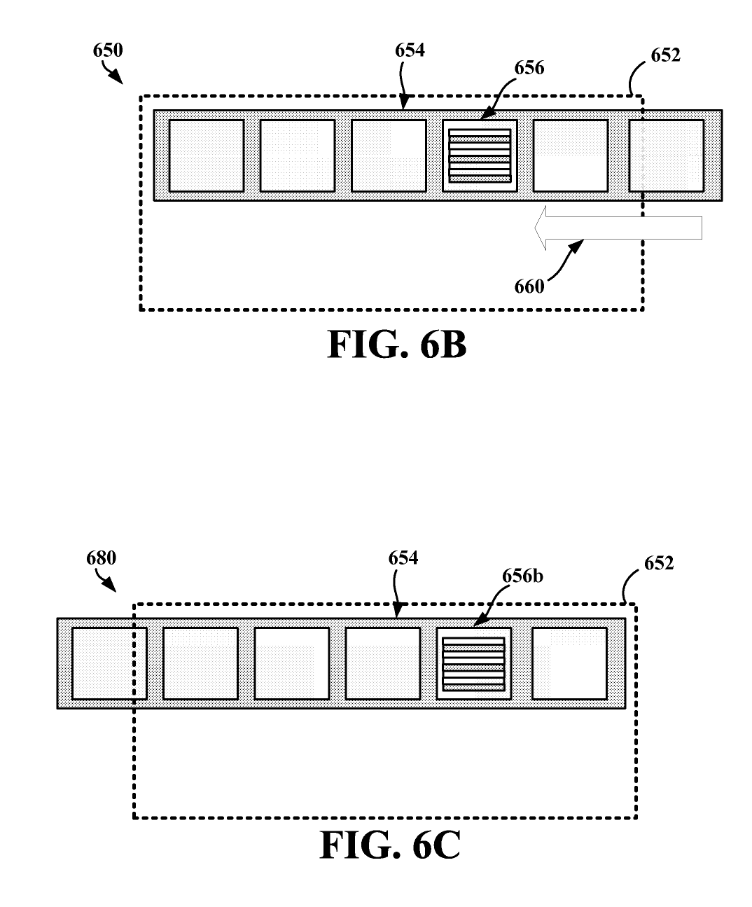

In accordance with another embodiment, a wearer of the wearable computing device tilts the device to a certain degree and the device responds by applying a visual manipulation (sometimes referred to as a manipulative action) to the selected content object. FIG. 6A shows an example head movement for interacting with the user interface. A user 604 of the wearable electronic device 602 may move his or her head with a sideways motion 606. The user 604 may wear the wearable electronic device 602 like a pair of glasses. Various means may be used for a user to interact with a user interface of the wearable electronic device 602. It may be desirable in some embodiments to provide an input to the user interface without having to touch the wearable electronic device 602. In some embodiments, the methods presented herein may be used responsive to the presentation of a user interface of a wearable electronic device 602. For example, a first motion of the wearable electronic device 602 may bring a user interface 504 within the view region 502. Once the user interface 504 is within the view region 502, the methods presented here may allow a user to interact with the user interface 504.

In one embodiment, a user may wish to pan across a user interface shown in the wearable electronic device 602. For example, a user may want to see items of a menu where some of the items are located outside his or her field of view. Therefore, a user 604 may turn his head toward the right, as indicated by motion 606, in order to pan the user interface to the right.

FIG. 6B shows aspects of an example user-interface after receiving movement data corresponding to a rightward movement. A movement in the right direction is merely an example. The view region 652 and menu 654 may move with respect to any movement. As shown, the user-interface 650 includes the view region 652 and the menu 654. A portion of the menu 654 may be located outside the view region 652.

As noted above, in response to receiving the movement data corresponding to a rightward movement of the wearable computing device, the wearable computing device may move one or both of the view region 652 and the menu 654 such that the menu 654 becomes more visible in the view region 652. The menu 654 may move to the left, as indicated by motion 660, in response to the user 604 (of FIG. 6A) moving his or her head to the right (e.g., motion 606). The menu 654 may appear to have a portion located outside of the view region 652.

In some embodiments, the upward movement, as disclosed in section 3 above, may bring the user-interface 650 into the view region 652. Once the user-interface 650 is in the view region 652, a second movement, possibly in either a left- or right-ward direction, may move the user-interface 650 within the view region 652. Additionally, the second movement, possibly in either a left- or right-ward direction, may selected a particular content objects 656 within the user interface menu 654. A user may be able to scroll through a list of particular content objects 656 by either the left- or right-ward movement.

As shown, the menu 654 is not fully visible in the view region 652. In other embodiments, however, the entire menu 654 may be visible in the view region 652 (as discussed with respect to FIG. 5B). In some embodiments, the extent to which the menu 654 is visible in the view region 652 may be based at least in part on an extent of the rightward movement.

Thus, the view region 652 may be moved in response to receiving data corresponding to a rightward movement. In some embodiments, the view region 652 may be moved in a rightward scrolling or panning motion. For instance, the view region 652 may appear to a wearer of the wearable computing device as if mapped onto the inside of a static sphere centered at the wearable computing device, and movement of the view region 652 may map onto movement of the real-world environment relative to the wearable computing device.

A speed, acceleration, and/or magnitude of the scrolling may be based at least in part on a speed, acceleration, and/or magnitude of the rightward movement. In still other embodiments, the view region 502 may be moved only when the right-ward movement exceeds a threshold speed, acceleration, and/or magnitude. In response to receiving data corresponding to an right-ward movement that exceeds such a threshold or thresholds, the view region 502 may pan, scroll, slide, or jump to a new field of view.

As shown in FIG. 6C, the user interface has scrolled to the left in response to head movement. A portion of the menu 654 has left the view region 652 off the left hand side. The selected object has responsively updated to select a particular content object 656b. Once the user has selected a content object, the user can the apply a manipulative action the selected content object.

In at least one embodiment, the manipulative action is scrolling the selected content object. Scrolling may be used, for example, when the selected content object is a text document, spreadsheet, list of items (e.g., a list of contacts in an address book), etc. For example, scrolling right on a list of contacts may move through each individual contact, moving some contacts off the display at the left of the view region and bringing some new contacts into display at the right of the view region. Similarly, scrolling a list of items (e.g., a list of emails in an email inbox, letters of a character input system) may bring some new items into display from one direction while moving some items off the display in the other direction. Other examples of scrolling are possible as well.

In at least one embodiment, the manipulative action is cycling the display to a new content object. Cycling may be used, for example, when the selected content object is associated with a group of other content objects. For example, in embodiments in which the selected content object is one image in a photo album, cycling may change the displayed image to another image from that photo album. In embodiments in which the selected content object is a web page, cycling may change the displayed webpage to a previously viewed webpage. Alternatively, cycling may change the selected content object to another content object from the menu 504. Other examples of cycling are possible as well, as are other examples of manipulative actions such as panning and other object movements.

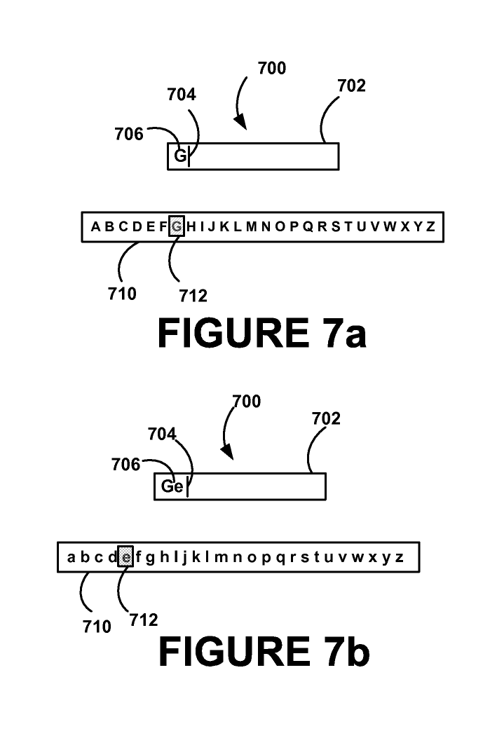

FIGS. 7A and 7B show an example of a text entry system for use with the methods and systems disclosed herein. FIGS. 7A and 7B show a character input system 700. The character input system may be used on the heads up display. The character input system comprises a text entry box 702 and a set of available characters 710. Within the text entry box 702 is a cursor 704 indicating current position in the text input box. Additionally, previously entered characters 706 are also shown in the text entry box 702.

To input characters a user may select a specific character with the cursor 712. In FIG. 7A the letter “G” is selected. To move to another character the user may turn his or her head to the left. The cursor 712 may responsively move to a new character, the letter “e” as shown in FIG. 7B. The head motion described herein may allow a repositioning of the cursor 712 to facilitate text entry. There may be a mathematical function that maps a user's head movement to a speed of scrolling through characters of the set of available characters 710.

Thus, a mathematical function may relate a head movement to a scroll speed. The movement may be mapped based on the magnitude of the movement (e.g. the number of degrees the user turned his or her head). In other embodiments, the movement may be mapped based on the movement speed (e.g. the number of degrees per second the user turned his or her head). In still further embodiments, the movement may be mapped based on additional movement parameters (e.g. the acceleration of the head movement or the impulse of the head movement). For example, the mathematical function may have a linear relationship between the movement speed and the scroll speed. For example, the user interface menu 654 may scrolled based on a fixed ratio speed multiplier. The ratio may be greater, less than, or equal to one. Thus, in one embodiment, a head movement of 5 degrees per second may translated to the user interface menu 654 scrolling at 10 degrees per second (assuming the user interface menu 654 may be considered a projection on to an imaginary sphere). Thus, if the head movement was increased to 10 degrees per second, the user interface menu 654 scrolling may be increased to 20 degrees per second due to the linear relationship.

In additional embodiments, the mathematical function may have a non-linear relationship between the movement speed and the scroll speed. For example, the user interface menu 654 may scrolled based on a quadratic speed multiplier. In one embodiment, a head movement of 2 degrees per second may translated to the user interface menu 654 scrolling at 4 degrees per second (assuming the user interface menu 654 may be considered a projection on to an imaginary sphere). Thus, if the head movement was increased to 5 degrees per second, the user interface menu 654 scrolling may be increased to 25 degrees per second due to the quadratic relationship.

The scrolling speed may also have a maximum speed as well. Thus, the scrolling rate my increase based on the mathematical formula, until a threshold speed it met. When the threshold is met, the scrolling speed does not increase further.

Although only linear and quadratic functions were discussed, the relationship between the head movement and the user interface scroll speed may be based on any mathematical relationship, including an exponential expression, a Sigmoid expression, an inverse exponential function or a polynomial function. Different use cases may be optimized with different functions.

In some additional embodiments, the user interface may scroll as if it had momentum and resistance (like friction). For example, a quick head movement could start the user interface scrolling a specific speed, the speed being determined by a mathematical function based on the speed or distance of the motion. The user interface scrolling may slow down based on a virtual friction coefficient. The faster the scrolling starts, the longer it may take to stop. The user may also be able to make a motion in the opposite direction to stop or slow down the user interface scrolling. The head movement may set an initial movement speed of the items in the user interface, but the movement of the items will slow based on the virtual resistance.

Additionally, the position sensor may include a filter on the position information. The filter may stop some movements from updating the user interface. For example, very small magnitude movements or very slow movements may be ignored as undesirable. Very small magnitude movements or very slow movements may be unintentional and reduce the user experience of the wearable electronic device. Additionally, in some embodiments very fast movements may be filtered as well. For example, the user of the head mounted display may be running and with each step have a quick head acceleration. It may be desirable to filter out the quick jarring acceleration caused by each step.

FIG. 8 is a flow diagram of one embodiment of the method for interacting with the user interface of the wearable electronic device presented herein. Some examples of method 800 may be performed by the example systems shown in FIGS. 1-4 in combination with the various user interfaces in FIGS. 5A, 5B, 5C, 5D, 6B, 6C, 7A, and 7B. Although the blocks of FIG. 8 are illustrated in a sequential order, these blocks may also be performed in parallel, and/or in a different order than those described herein. Also, the various blocks may be combined into fewer blocks, divided into additional blocks, and/or eliminated based upon the desired implementation.

Method 800 may begin at block 801, where the wearable electronic device monitors position information. The wearable electronic device may use various sensors, such as a gyroscope or an accelerometer, to monitor its position. In some embodiments, a GPS sensor may also be coupled to allow the wearable electronic device to know its absolute position. However, for most embodiments disclosed, relative position information provided by a gyroscope or an accelerometer may be sufficient. In some embodiments, block 801 may also store position information to a memory. The memory may hold location information for a period of time for use in other portions of the methods discussed herein. The user may also be able to clear the memory whenever he or she wishes. Additionally, the storage may be configured to store the position information for a finite amount of time, such as 2 seconds, before deleting the information.

At block 802, the wearable electronic device may calculate a direction of movement for the wearable electronic device. A processor may receive the movement information that was monitored at block 801. In some embodiments, a processor may calculate the direction of movement on the fly based on data provided by sensors in the wearable electronic device. In other embodiments, the processor may read position information from memory and calculate the direction of movement.

At block 803, the wearable electronic device may calculate a movement parameter for the wearable electronic device. The processor may receive the movement information that was monitored at block 801 or the direction of movement calculated at block 802. In some embodiments, a processor may calculate the direction of movement on the fly based on data provided by sensors in the wearable electronic device. In other embodiments, the processor may read position information from memory and calculate the direction of movement. In still further embodiments, the processor may calculate the movement speed based on the calculated direction of movement. The movement parameter may be either the movement speed, movement acceleration or movement impulse.

At block 804, the wearable electronic device may scroll an element in the user interface based at least on the calculated direction. In some embodiments, a user interface menu 654 may be scrolled within the view region 502. The user interface menu 654 may be scrolled in the opposite direction of the calculated direction. For example, if a user of the head mounted display moved his or her head to the left, the user interface may be scrolled to the right. Thus, it would appear like the user was able to scroll through the interface. The speed of the scrolling may be based on the calculated movement parameter.

For example, the movement parameter may be the movement speed. Therefore, the user interface menu 654 may scroll in the opposite direction of the movement based on the movement speed. In one embodiment, the scrolling speed may have a non-linear relationship with the movement speed. In other embodiments, different movement parameters may be used to calculate the scrolling speed. For example, the movement acceleration or movement impulse could also be used to calculate a scrolling speed of the interface menu 654.

### 4. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method of entering text for head mounted display (HMD) comprising:
(a) receiving data that indicates a position of the HMD;
(b) calculating a direction of movement for the HMD;
(c) calculating a movement parameter for the HMD; and
(d) scrolling a text-entry menu within the user interface based on the calculated movement direction and the calculated movement parameter, wherein the scrolling has an associated speed, and wherein the associated speed has a non-linear functional relationship to the calculated movement parameter.

2. The method of claim 1, wherein the non-linear functional relationship is a quadratic relationship.

3. The method of claim 2, wherein the non-linear functional relationship is a polynomial function.

4. The method of claim 1, wherein the text-entry menu within the user interface comprises a scrollable list of items.

5. The method of claim 1, wherein the movement parameter is one of either movement speed, movement acceleration or movement impulse.

6. The method of claim 1, wherein the direction of movement corresponds to a rotation around an axis.

7. The method of claim 6, wherein the axis is defined by a head position of a wearer of the HMD.

8. The method of claim 1, wherein (a), (b), (c), and (d) are performed responsive to a first motion, wherein the first motion causes the user interface to be displayed.

9. A system comprising:
at least one processor; and
data storage comprising user-interface logic executable by the at least one processor to:
(a) receive data that indicates a position of a head mounted display (HMD);
(b) calculate a direction of movement for the HMD;
(c) calculate a movement parameter for the HMD; and
(d) scroll a text-entry menu within the user interface based on the calculated movement direction and the calculated movement parameter, wherein the scrolling has an associated speed, and wherein the associated speed has a non-linear functional relationship to the calculated movement parameter.

10. The system of claim 9, wherein the movement parameter is one of either movement speed, movement acceleration or movement impulse.

11. The system of claim 9, wherein the non-linear functional relationship is a quadratic relationship.

12. The system of claim 11, wherein the non-linear functional relationship is a polynomial function.

13. The system of claim 9, wherein the element text-entry menu within the user interface comprises a scrollable list of items.

14. The system of claim 9, wherein the direction of movement corresponds to a rotation around an axis.

15. The system of claim 14, wherein the axis is defined by a head position of a wearer of the HMD.

16. The system of claim 9, further comprising user-interface logic executable by the at least one processor to perform (a), (b), (c), and (d) responsive to a first motion, wherein the first motion causes the user interface to be displayed.

17. A non-transitory computer readable medium having stored therein instructions executable by a computing device to cause the computing device to perform functions comprising:
(a) receiving data that indicates a position of a head mounted display (HMD);
(b) calculating a direction of movement for the HMD;
(c) calculating a movement speed for the HMD; and
(d) scrolling a text-entry menu within the user interface based on the calculated movement direction and the calculated movement speed, wherein the scrolling has an associated speed, and wherein the associated speed has a non-linear functional relationship to the calculated movement speed.

18. The computer readable medium of claim 17, wherein the movement parameter is one of either movement speed, movement acceleration or movement impulse.

19. The computer readable medium of claim 17, wherein the non-linear functional relationship is a quadratic relationship.

20. The computer readable medium of claim 19, wherein the non-linear functional relationship is a polynomial function.

21. The computer readable medium of claim 17, wherein the text-entry menu within the user interface comprises a scrollable list of items

22. The computer readable medium of claim 17, wherein the direction of movement corresponds to a rotation around an axis.

23. The computer readable medium of claim 22, wherein the axis is defined by a head position of a wearer of the HMD.

24. The computer readable medium of claim 17, further comprising user-interface logic executable by the at least one processor to perform (a), (b), (c), and (d) responsive to a first motion, wherein the first motion causes the user interface to be displayed.
